(19) United States
(12) Patent Application Publication
(10) Pub. No.: US 2016/0333886 A1
(43) Pub. Date: Nov. 17, 2016

(54) AXIAL COMPRESSOR AND USE OF AN AXIAL COMPRESSOR

(71) Applicant: Lars Skovlund ANDERSEN, Mårslet (DK)

(72) Inventor: Lars Skovlund ANDERSEN, Mårslet (DK)

(21) Appl. No.: 14/899,087

(22) PCT Filed: Jul. 3, 2014
(86) PCT No.: PCT/DK2014/050195

§ 371 Date: Dec. 16, 2015

(51) Int. Cl. F04D 25/06; F04D 29/32; F04D 27/00; F04D 29/66; F04D 19/02; F04D 29/58

(52) U.S. Cl. CPC F04D 25/0613; F04D 19/024; F04D 19/026; F04D 29/5806; F04D 27/004; F04D 29/661; F04D 29/321; F05B 2210/12; F05B 2240/30; F05B 2240/12; F05B 2240/61

(57) ABSTRACT

Disclosed is an axial compressor (1) comprising a first compressor stage (2) including a first impeller (4) driven by first drive means (6), and a second compressor stage (3) including a second impeller (5) driven by second drive means (7). The second compressor stage (3) is arranged in axial continuation of the first compressor stage (2) and the first drive means (6) is arranged at the hub (8) of the first impeller (4) and the second drive means (7) is arranged at the hub (8) of the second impeller (5). Use of an axial compressor (1) is also disclosed.

### FIELD OF THE INVENTION

The present invention relates to an axial compressor comprising a first compressor stage and a second compressor stage. The invention further relates to use of an axial compressor.

### BACKGROUND OF THE INVENTION

It is known to use axial compressors for compressing the vapor or gas in e.g. freeze-drying machines, heat pumps and vapor-compression refrigeration systems because axial compressors are known to have high efficiency and have a large volume flow rate, particularly in relation to their cross-section compared to other compressor types.

Axial compressors typically consist of rotating and stationary components. A centrally arranged shaft drives a number of compressor stages (such as three to eight stages) each including a rotating impeller and stationary guide vanes where the rotating impellers accelerate the fluid while the stationary guide vanes, convert the increased rotational kinetic energy into static pressure through diffusion and redirect the flow direction of the fluid, preparing it for the impeller of the next stage. The volume of each compressor stage is typically reduced in the flow direction in accordance with the compression of the fluid.

From US 2013/0022474 A1 it is known to use an axial compressor for compressing the refrigerant in a refrigerator circuit. But this compressor design is difficult to control in relation to vibration, stall and other.

It is therefore an object of the present invention to provide for an advantageous compressor design allowing for better control.

### The Invention

The invention relates to an axial compressor comprising a first compressor stage including a first impeller driven by first drive means, and a second compressor stage including a second impeller driven by second drive means. The second compressor stage is arranged in axial continuation of the first compressor stage and the first drive means is arranged at the hub of the first impeller and the second drive means is arranged at the hub of the second impeller.

Arranging the drive means of the compressor stages at the hub of each stage allows for individual control of the power and rotational speed of the impeller of each stage. It hereby is possible to optimise the operation of each stage individual e.g. in relation to vibrations, output, cavitation, stall or other and thus increase the overall output and durability of the compressor.

It should be noted that in this context the term “drive means” should be understood as any kind of actuator, motor i.e. electrical, pneumatic or hydraulic motor, combustion engine or similar device capable of driving an impeller in an axial compressor, so that the impeller may compress the fluid being displaced by the impeller.

In an aspect of the invention, said first impeller is arranged to substantially encircle said first drive means and wherein said second impeller is arranged to substantially encircle said second drive means.

Arranging the drive means inside the hub of the impeller so that the impeller encircles the drive means is advantageous in that it enables a very compact compressor design and thus ensures that the distance between the stages can be reduced to increase the efficiency of the compressor.

In an aspect of the invention, said first compressor stage and said second compressor stage are mounted on the same centrally arranged shaft means.

Mounting the compressor stages on the same centrally arranged shaft is advantageous in that it entails a simple compressor design and a simple manufacturing procedure.

It should be noted that the term “same centrally arranged shaft means” does not limit the shaft means to being formed as one monolithic part. I.e. in an embodiment the shaft means can be formed by several connected shaft parts.

In an aspect of the invention, said first impeller is arranged to displace a fluid in a first axial direction of said axial compressor when said first impeller is rotating in a first direction and wherein said second impeller is arranged to also displace said fluid in said first axial direction of said axial compressor when said second impeller is rotating in a second direction, wherein said first direction is opposite said second direction.

Designing the impellers to move the fluid in opposite directions—if the impellers are rotated in the same direction—and then rotating them in opposite directions entails that the impellers move the fluid in the same axial direction even though they are rotating in opposite directions. This is advantageous in that the fluid leaving the first impeller will then be hurled out in a direction that is opposite the rotational direction of the second impeller i.e. the fluid leaving the first impeller will be pushed into the second impeller, thus increasing the efficiency of the compressor. Furthermore, since the fluid is now leaving an impeller in a direction opposite the direction of rotation of the next impeller there is no longer any need for stationary guide vanes between the impellers of the compressor stages. Since the stationary guide vanes add mass, volume, frictional surfaces, and costs to the compressor it is highly advantageous if the guide vanes can be avoided to increase compressor efficiency—since energy is no longer lost due to friction and direction change of the fluid through the stationary guide vanes—and enabling a more compact and inexpensive compressor.

In an aspect of the invention, said first drive means and said second drive means are electrical motors.

Since the drive means have to be arranged in the hub of the impellers and the impellers have to be arranged relatively close to each other to increase the efficiency of the compressor, it is important that the drive means are compact, easy to control and easy to power. Since electrical motors can be made with a very high torque output in relation to their size and since an electrical motor in principle only needs to be connected to a power source through an electrical cable it is advantageous to use electrical motors as drive means in the impellers.

In an aspect of the invention, said electrical motors each comprise a stator part and a rotor part and wherein said rotor part is arranged to encircle said stator part.

Arranging the rotor around the stator of the motor enables a more compact and inexpensive compressor stage design in that the impellor in principle can be connected to the outside of the rotor.

In an aspect of the invention, said first drive means and said second drive means can be actively cooled in that said drive means comprises one or more cooling conduits through which a flow of cooling fluid can be established.

It is advantageous to actively cool the drive means in that they hereby can be formed more compact—in relation to their torque output—and because efficient cooling can be performed no matter what fluid is being compressed and no matter the temperature of this fluid.

In an aspect of the invention, said axial compressor comprises a cooling circuit in which cooling conduits directs a cooling fluid into said first drive means from which it then continues through said second drive means before said cooling conduit directs said cooling fluid to cooling means.

Cooling fluid then have to be transported to, through and away from each drive means in the compressor. However, making the cooling fluid flow through both the first drive means and the second drive means before it returns to the cooling means is advantageous in that the number of cooling fluid conduits to and from the pair of drive means can be reduced, hereby simplifying the compressor design.

In an aspect of the invention, said cooling means is arranged externally to said axial compressor.

Heat has to be removed from the cooling fluid by passing it through cooling means such as a heat exchanger, heat sinks or other. Such cooling means are space consuming and it is therefore advantageous to arrange the cooling means outside the compressor. Furthermore, given the high temperature inside the compressor it would be highly impractical to cool the cooling fluid inside the compressor. Thus, for the cooling means to function efficiently they have to be arranged at or outside the compressor casing.

In an aspect of the invention, said axial compressor comprises one or more further compressor stages each including an impeller driven by drive means, wherein said one or more further compressor stages are arranged in axial continuation of said first and said second compressor stages and wherein said drive means of said one or more further compressor stages are arranged at the hub of said impeller of said one or more further compressor stages.

Providing the compressor with three or more compressor stages—having the same configuration as the first and the second stages—is advantageous in that it is possible to form a very compact compressor having a high capacity and pressure ratio.

In an aspect of the invention, an active volume of said first compressor stage is bigger than an active volume of said second compressor stage.

Each compressor stage of the compressor compresses the fluid more than the previous stage and since the volume of the fluid decreases it is advantageous that the active volume of the stages decreases accordingly to increase the pressure in the compressed fluid as it travels through the compressor.

It should be noted that the term “active volume” in this context means the volume through which the fluid flows i.e. the volume of each stage through which the fluid passes when it is displaced by the impeller of said stage.

In an aspect of the invention, said first impeller is wider than said second impeller.

Reducing the width of the impellers in the flow direction through the compressor is advantageous in that it hereby is possible to adapt the active volume of the compressor stages to the actual compression of the fluid.

In an aspect of the invention, a pitch angle of blade means of said first impeller is bigger than a pitch angle of blade means of said second impeller.

It is advantageous to reduce the pitch angle of the blades of the impellers in the flow direction in the compressor, in that it hereby is possible to ensure that e.g. the stall limit is maintained substantially at the same RPM even through the flow properties of the fluid changes due to rise in pressure and temperature.

In an aspect of the invention, said drive means of said compressor stages are substantially identical.

Providing the first, the second and subsequent compressor stages with the same driven means such as substantially identical electric motors, is advantageous in that the compressor hereby becomes more inexpensive and the compressor simpler to manufacture and maintain.

The invention relates to use of an axial compressor according to any of the previously discussed axial compressors for compressing water vapour in a refrigeration cycle where water is the refrigerant.

Since refrigerants such as chlorofluorocarbon (CFC) gases are no longer desired as the refrigerant in refrigeration cycles it is natural to look towards water for a natural harmless alternative.

However, the volumetric cooling capacity of water vapor is very low and large volume flows therefore have to be compressed with relatively high pressure ratios if water is to replace e.g. CFC gases. Therefore, the use of water as a refrigerant, compared to classical refrigerants, requires approximately 200 times the volume flow, and about twice the pressure ratio for the same applications. Because of the thermodynamic properties of water vapor, this high pressure ratio requires approximately a two- to four-times higher compressor tip speed depending on the impeller design, while the speed of sound is approximately 2.5 times higher. It is therefore advantageous to use an axial compression according to the present invention to compress water vapour in a refrigerator cycle in that such an axial compressor is more efficient than traditional compressors.

### FIGURES

The invention will be explained further herein below with reference to the figures in which:

FIG. 1 shows an axial compressor, as seen from the side,

FIG. 2 shows an axial compressor without casing, as seen from the side,

FIG. 3 shows a cross section through the middle of an axial compressor, as seen from the side,

FIG. 4 shows a cross section through an axial compressor, as seen from the front,

FIG. 5 shows a simplified representation of the supply to drive means, as seen from the side, and

FIG. 6 shows a cross section through the middle of an axial compressor, as seen in perspective.

### DETAILED DESCRIPTION

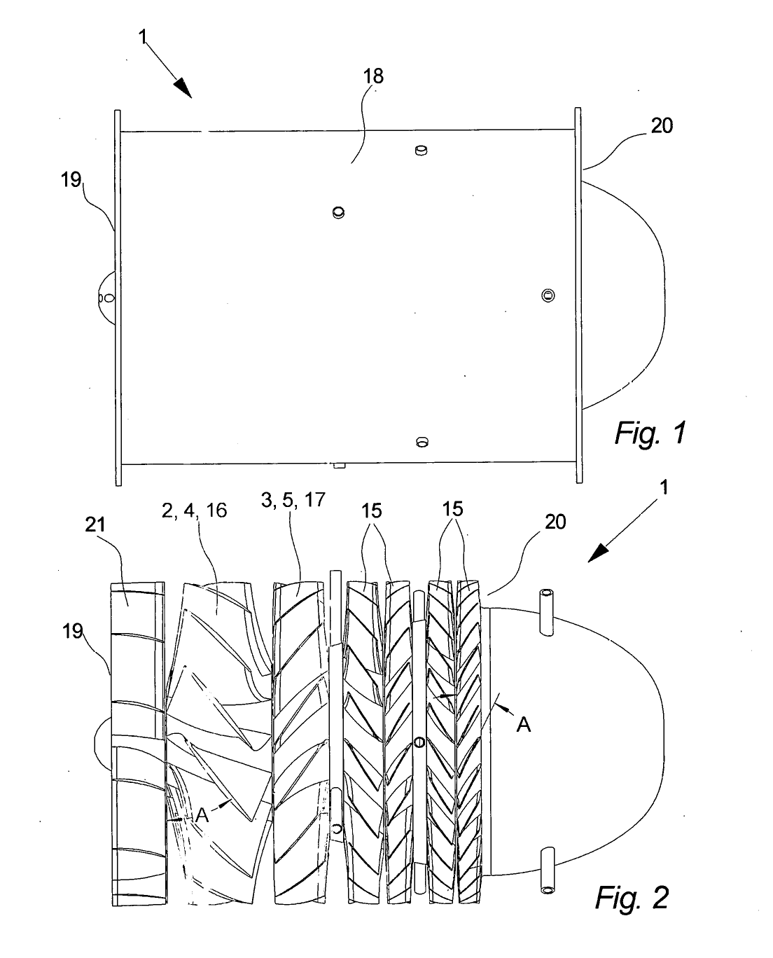

FIG. 1 shows an axial compressor 1, as seen from the side.

In this embodiment the compressor 1 is shown comprising its casing 18 so the present figure does not tell much except that this embodiment of an axial compressor 1 is very compact and easy to install.

FIG. 2 shows an axial compressor 1 without casing 18, as seen from the side.

In this embodiment the axial compressor 1—which is the same as the one disclosed in FIGS. 1, 3, 4 and 6—comprises six independent compressor stages 2, 3, 15. However in another embodiment the compressor 1 could comprise another number of compressor stages 2, 3, 15 such as two, three, four, five, eight or more.

At the inlet 19 of the compressor 1 is first arranged inlet guide vanes 21 to guide the incoming vapour or gas into the first compressor stage 2. If seen from the front of the compressor 1 i.e. in the direction of fluid flow through the compressor 1 during normal use of the compressor 1, the first impeller 4 will rotate counter-clockwise to draw the fluid from the inlet 19 at push it in the axial direction of the outlet 20. When the fluid leaves the first impeller it will not only move in the axial direction towards the outlet 20. The motion of the fluid will also have a tangential component making the fluid also move in a counter-clockwise direction. This is advantageous in that in this embodiment the second compressor stage 3 is provided with a second impeller 5 rotating in a clockwise direction—if seen from the front of the compressor 1—and since the pitch angle A of the blades 17 of the second impeller 5 is substantially reversed in relation to the pitch angle A of the first impeller 4 the second impeller 5 will also push the fluid in direction of the outlet 21 so that the fluid is further compressed. From the second compressor stage 3 the fluid will enter a further compressor stage 15 in which the impeller will rotate in the same direction as the impeller of the first stage 2—and the blades of this impeller is orientated in substantially the same way as the blades 16 of the first impeller 4. This, counter-rotating stage design continues all the way through the compressor 1 so that all the stages 2, 3, 15 are designed to displace the fluid in the same axial direction—i.e. from the inlet 19 to the outlet 20 of the compressor 1—even though all the impellers rotate in a direction opposite than its neighbouring impellers. However, in another embodiment only some of the compressor stages would be arranged to counter-rotate or all the stages where designed to push the fluid in the same axial direction while rotating in the same direction.

In this embodiment each compressor stage 2, 3, 15 is substantially as wide as the width of the impeller of the stage, however in another embodiment one or more of the stages could be wider than the impeller e.g. to allow space for cooling of the compressed fluid or other.

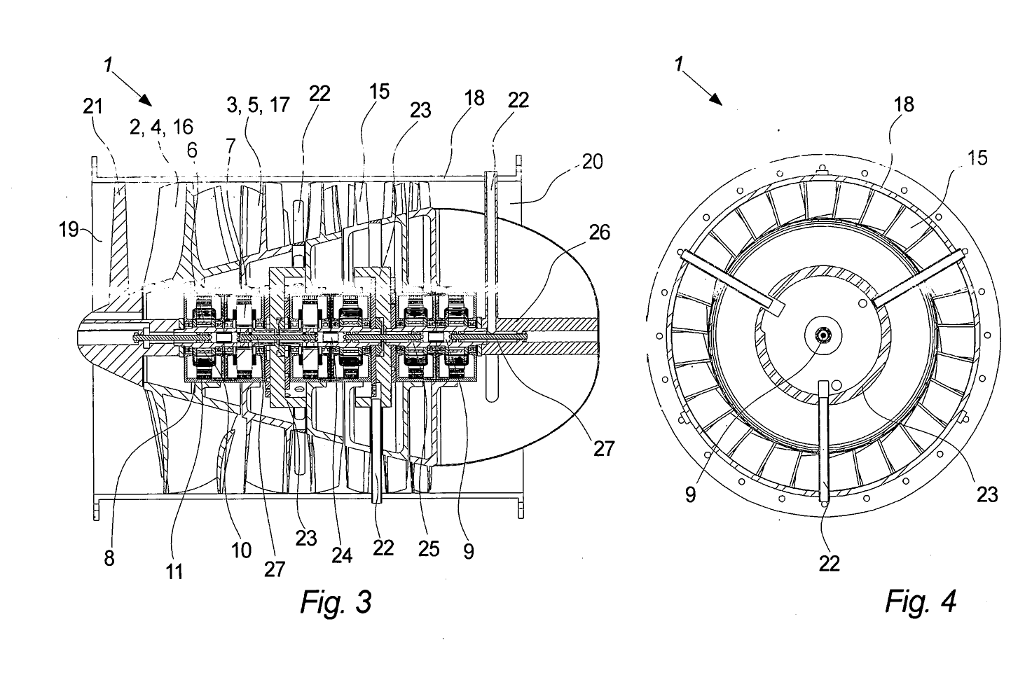

In this embodiment the width of the compressor stages 2, 3, 15 gradually decrease from the first compressor stage 2 towards the last compressor stage. The impellers of the compressor stages 2, 3, 15 can rotate at a speed of up to 15.000 RPM or even more and at this speed the blades are primarily stressed by the centrifugal forces resulting from their inherent mass i.e. in comparison the force excreted by the fluid is relatively small. Thus, under these circumstances the blade-length to blade-width ratio is ideally around 1.3. Since the fluid is more and more compressed as it moves through the compressor stages 2, 3, 15, the active volume of the first compressor stage 2 is bigger than the active volume of the second compressor stage 3, which in turn is bigger than the active volume of the next compressor stage 15 and so on. Thus, to reduce the active volume in accordance with the compression, either the inner diameter of each stage 2, 3, 15 could be increased or the outer diameter of each stage 2, 3, 15 could be reduced. In this case the inner diameter of the stages is gradually increased—as seen more clearly in FIG. 3—but as the inner diameter is increased, and the outer diameter is maintained constant, the length of the blades also has to be reduced accordingly. And to maintained the desired ratio between length and width of the blades the width of the blades will also have to be reduced accordingly. Since it is advantageous to arrange the impellers as close to each other as possible to ensure a compact design and to utilise the rotating motion of the fluid it follows that the narrower the blades becomes the narrower the compressor stages 2, 3, 15 becomes—as it is clearly seen in FIGS. 2 and 3.

As the fluid moves along the compressor stages 2, 3, 15 it becomes more and more compressed and its temperature rises. Thus, the flow properties of the fluid also changes and in this case the pitch angle A is reduced a few degrees for every impeller in the direction of flow.

However, in another embodiment the pitch angle A would only be reduced on some of the impellers 4, 5 or all the impellers would have substantially the same pitch angle A.

It is important to point out that the present pitch angle A is measured at the tip of the blade means 16, 17 i.e. in this configuration at the same diameter. To adapt the pitch angle A of the blades to its actual speed through the fluid the blades 16, 17 are in this embodiment curved so that near the hub 8—where the blade moves the slowest through the fluid—the pitch angle of the blades is higher than the pitch angle A of the blades at the tip of the blades—where the blades 16, 17 moves the fastest.

However, in another embodiment the blades could be formed more or less straight with a constant pitch angle throughout the length of the blades 16, 17.

In this embodiment all the blades 16, 17 of all the impellers 4, 5 are made from aluminium but in another embodiment some or all of the blades of some or all the impellers—e.g. the last compressor stages—could be made from a different material such as titanium or composites.

FIG. 3 shows a cross section through the middle of an axial compressor 1, as seen from the side.

In this embodiment all six compressor stages 2, 3, 15 are provided with an impeller 4, 5 driven by drive means 6, 7 arranged in the hub 8 of the respective impeller 4, 5. However, in another embodiment e.g. only two, three or four of the compressor stages 2, 3, 15 would comprise hub-integrated drive means 6, 7.

In this embodiment all the drive means 6, 7 are electric motors and all the motors are configured so that the stationary stator part 10 is arranged at the centre and the rotating rotor part 11 is arranged so that it encircles the stator part 10. This motor configuration is also called an “outrunner” or “external-rotor” configuration, in that the radial-relationship between the coils and magnets is reversed in relation to the normal motor configuration i.e. in this configuration the stator coils 10 form the centre (core) of the motor, while the permanent magnets spin within an overhanging rotor 11 which surrounds the core.

However, in another embodiment none or only some of the drive means 6, 7 would be electric motors and/or none or only some of the electric motors would be formed with an external-rotor configuration.

In this embodiment the drive means 6, 7 are arranged in pairs so that the drive means 6, 7 of the first two compressor stages 2, 3 are arranged back to back, the drive means of the following two compressor stages are also arranged back to back and the drive means of the last two compressor stages are also arranged back to back. This pair-design is advantageous in that it provides for a compact design while at the same time enabling that all drive means may be supplied with power, cooling fluid, signal cables and other through the shaft means from at least one side.

In this embodiment all the drive means are arranged on the same shaft means 9, which in this case comprises a plurality of individual shaft parts 24, 25 arranged overlapping or end to end in axial continuation of each other. However, in another embodiment the shaft means 9 could comprise at least one continuous shaft part.

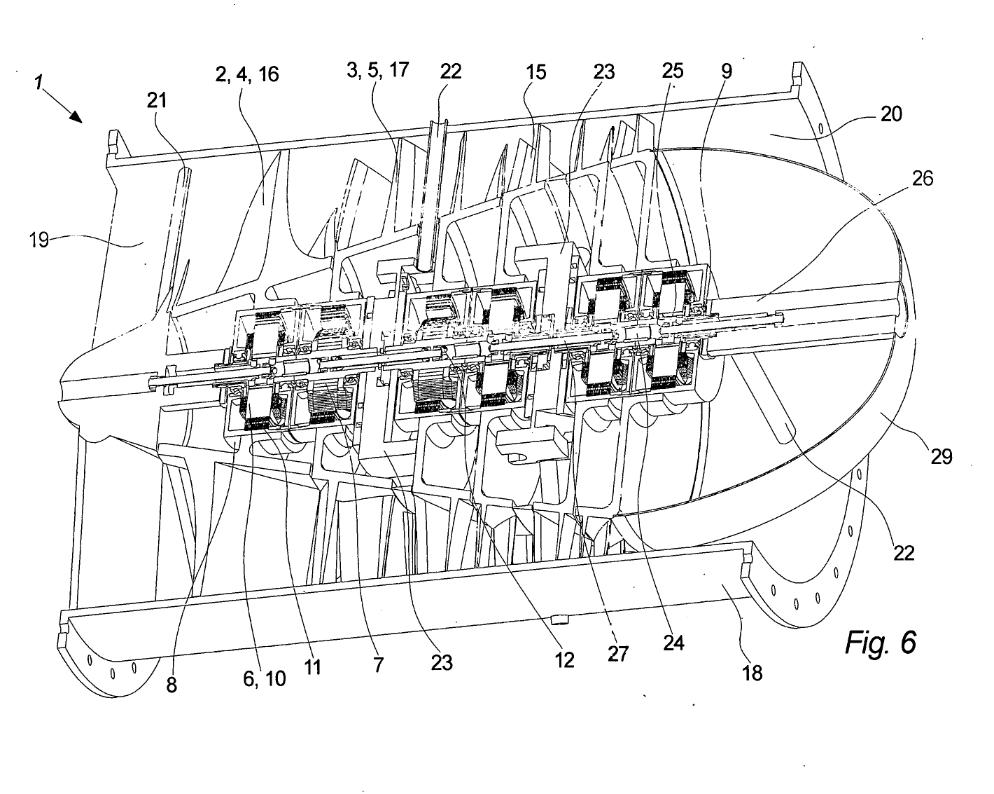

Actually, in this embodiment the shaft means 9 comprise a number of hollow continuous drive means shaft part 25 each extending through a drive means 6, 7. Between the pairs of drive means 6, 7 these drive means shaft parts 25 are connected by a rigid and hollow shaft connector 24. The free ends of the drive means shaft parts 25 of such a pair of drive means are then supported by the hub 8 of the inlet guide vanes 21, the intermediately arranged support parts 23 (to be discussed later) and the rear support part 26 so that each pair of compressor stages 2, 3, 15 in principle are individually suspended, in that the drive means shaft parts 25 is not connected between the pairs of compressor stages 2, 3, 15 in other ways than by means of a centre rod 27 arranged to maintain the axial position of the pairs of compressor stages 2, 3, 15. The present shaft arrangement can be seen more clearly on FIG. 6.

In this embodiment refrigerant and power cables are lead to the drive means 6, 7 through the outermost ends of the shaft means 9 and through hollow support arms 22 extending through the casing 18 and into support parts 23 arranged between the pairs of drive means 6, 7. The main function of the support arms 22 and the support parts 23 are to offer support and stability to the compressor stages 2, 3, 15 but in this embodiment they are also used for distributing electrical power, cooling fluid and other to the compressor stages 2, 3, 15.

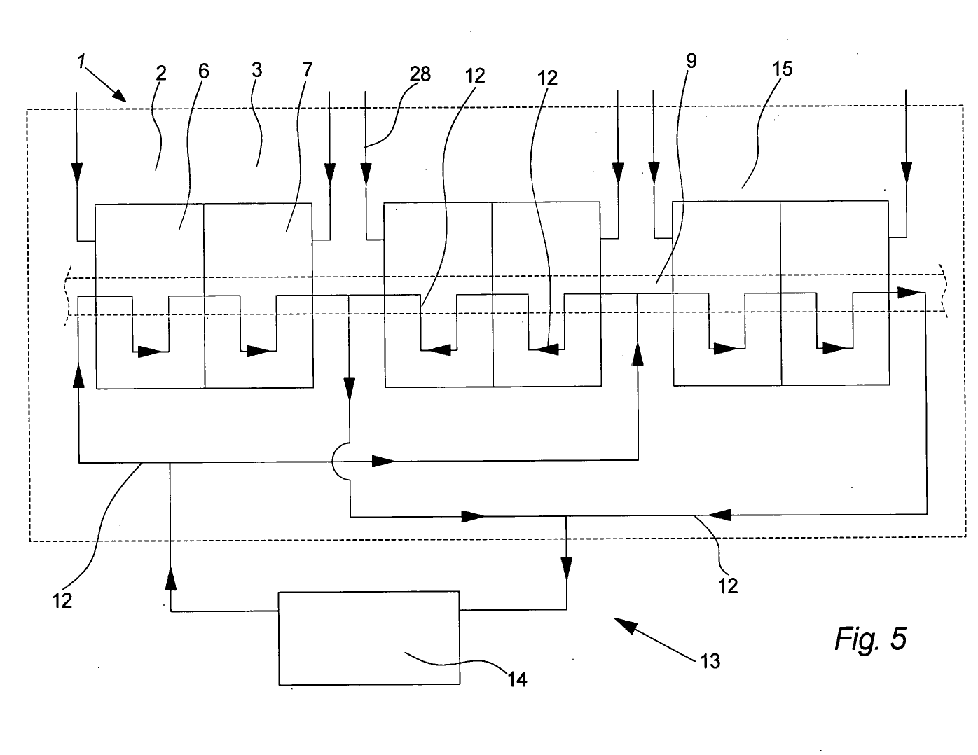

FIG. 4 shows a cross section through an axial compressor 1, as seen from the front. The present cross section is made down through a support part 23 so that it is clearly shown that coolant may enter through one of the support arms 22, coolant may exit through another support arm 22 and power cables, signal cables and other may enter through the third support arm 22. However, in another embodiment the support part 23 may be suspended by another number of support arms 22 such as one, two, four, six or more.

FIG. 5 shows a simplified representation of the supply to drive means 6, 7, as seen from the side.

In this embodiment it is disclosed how the drive means 6, 7 are supplied and cooled actively.

The cooling circuit 13 is in this embodiment arranged as follows: From the cooling means 14—in this case arranged outside the casing 18 of the compressor 1—the cold coolant is directed to the first drive means 6 through the hollow shaft means 9 by means of cooling conduits 12. Inside the first drive means 6 is arranged cooling conduits 12 ensuring that the coolant efficiently removes heat before it exits the first drive means 6 through the other end of the hollow shaft means 9. Through a first end of the shaft means 9 extending through the second drive means 7 the coolant now enters the second drive means 7 where it is directed through cooling conduits 12 before it exits the second drive means 7 through the other end of the shaft means 9 extending through the second drive means 7 and through cooling conduits 12—comprising the support arms 22—is lead back to the cooling means 14 to be re-cooled. Simultaneously coolant is also via the other support part lead to both the second and the final pairs of drive means.

As indicated power supply 28 leads power to all the drive means 6, 7 by also being directed through support arms 22, support parts etc.

FIG. 6 shows a cross section through the middle of an axial compressor 1, as seen in perspective.

In this embodiment the compressor is provided with a rear cone 29 arranged to ensure as little turbulence as possible in the flow of compressed fluid leaving the compressor at very high speed regaining dynamic pressure to static head

An axial compressor 1 according to the present invention can be used in many applications. One application would be in a vapor-compression refrigeration system which is typically used for lowering the temperature of an enclosed space. Such systems typically comprises the following four components: a compressor 1, a condenser, a thermal expansion valve (also called a throttle valve), and an evaporator. In such systems circulating refrigerant—such as water—enters the compressor 1 typically in the form of saturated vapour to be compressed to a higher pressure, resulting in a higher temperature as well. The hot, compressed vapor is then routed through the condenser where it is cooled and condensed into a liquid so that the circulating refrigerant rejects heat from the system. The condensed liquid refrigerant is next routed through an expansion valve where it undergoes an abrupt reduction in pressure lowering the temperature of the liquid/vapor refrigerant mixture to where it is colder than the temperature of the enclosed space to be refrigerated. The mixture is then routed through the evaporator where the liquid part of the cold refrigerant mixture evaporates, while lowering the temperature of the enclosed space to a desired temperature. The evaporator is where the circulating refrigerant absorbs and removes heat which is subsequently rejected in the condenser. To complete the refrigeration cycle, the refrigerant vapor from the evaporator is again a saturated vapor and is routed back into the compressor 1.

Axial compressors according to the present invention can also advantageously be used in relation with heat-pump applications which in principle is the same as the above mentioned vapor-compression refrigeration system. The typical difference is that heat pumps are used for raising the temperature in an enclosed space as opposed to lowering it.

Axial compressors according to the present invention can also be used in other applications such as in freeze-drying machines where the axial compressor is used for establishing the vacuum needed for achieving a desirable freeze-drying result.

In the foregoing, the invention is described in relation to specific embodiments of axial compressors 1, compressor stages 2, 3, 15, impellers 4, 5 and other as shown in the drawings, but it is readily understood by a person skilled in the art that the invention can be varied in numerous ways within the scope of the appended claims.

### LIST

1. Axial compressor
2. First compressor stage
3. Second compressor stage
4. First impeller
5. Second impeller
6. First drive means
7. Second drive means
8. Hub
9. Shaft means
10. Stator part
11. Rotor part
12. Cooling conduits
13. Cooling circuit
14. Cooling means
15. Further compressor stages
16. First blade means
17. Second blade means
18. Compressor casing
19. Inlet of compressor
20. Outlet of compressor
21. Inlet guide vanes
22. Support arm
23. Support part
24. Shaft connector
25. Drive means shaft part
26. Rear support part
27. Centre rod
28. Power supply
29. Rear cone
A. Pitch angle of impeller blade

1. An axial compressor comprising:
a first compressor stage including a first impeller driven by first drive means, and
a second compressor stage including a second impeller driven by second drive means,
wherein said second compressor stage is arranged in axial continuation of said first compressor stage and wherein said first drive means is arranged at the hub of said first impeller and said second drive means is arranged at the hub of said second impeller.

2. An axial compressor according to claim 1, wherein said first impeller is arranged to substantially encircle said first drive means and wherein said second impeller is arranged to substantially encircle said second drive means.

3. An axial compressor according to claim 1, wherein said first compressor stage and said second compressor stage are mounted on the same centrally arranged shaft means.

4. An axial compressor according to claim 1, wherein said first impeller is arranged to displace a fluid in a first axial direction of said axial compressor when said first impeller is rotating in a first direction and wherein said second impeller is arranged to also displace said fluid in said first axial direction of said axial compressor when said second impeller is rotating in a second direction, wherein said first direction is opposite said second direction.

5. An axial compressor according to claim 1, wherein said first drive means and said second drive means are electrical motors.

6. An axial compressor according to claim 5, wherein said electrical motors each comprise a stator part and a rotor part and wherein said rotor part is arranged to encircle said stator part.

7. An axial compressor according to claim 1, wherein said first drive means and said second drive means can be actively cooled in that said first and second drive means comprise one or more cooling conduits through which a flow of cooling fluid can be established.

8. An axial compressor according to claim 7, wherein said axial compressor comprises a cooling circuit in which cooling conduits directs a cooling fluid into said first drive means from which it then continues through said second drive means before said cooling conduit directs said cooling fluid to cooling means.

9. An axial compressor according to claim 8, wherein said cooling means is arranged externally to said axial compressor.

10. An axial compressor according to claim 1, wherein said axial compressor comprises one or more further compressor stages each including an impeller driven by drive means, wherein said one or more further compressor stages are arranged in axial continuation of said first and said second compressor stages and wherein said drive means of said one or more further compressor stages are arranged at the hub of said impeller of said one or more further compressor stages.

11. An axial compressor according to claim 1, wherein an active volume of said first compressor stage is bigger than an active volume of said second compressor stage.

12. An axial compressor according to claim 1, wherein said first impeller is wider than said second impeller.

13. An axial compressor according to claim 1, wherein a pitch angle (A) of first blade means of said first impeller is bigger than a pitch angle (A) of second blade means of said second impeller.

14. An axial compressor according to claim 1, wherein said first and second drive means of said first and second compressor stages are substantially identical.

15. Use of an axial compressor according to claim 1 for compressing a water vapour in a refrigeration cycle where water is the refrigerant.
